(19) United States
(12) Patent Application Publication
(10) Pub. No.: US 2025/0158336 A1
(43) Pub. Date: May 15, 2025

(54) CONNECTOR

(71) Applicant: YAZAKI CORPORATION, Tokyo (JP)

(72) Inventors: Masaaki Iwabe, Makinohara-shi (JP); Yasuharu Kondo, Makinohara-shi (JP)

(21) Appl. No.: 18/927,804

(22) Filed: Oct. 25, 2024

(30) Foreign Application Priority Data
Nov. 9, 2023 (JP) 2023-191621

(51) Int. Cl. H01R 13/688; H01R 4/34; H01R 13/506

(52) U.S. Cl. CPC H01R 13/688; H01R 4/34; H01R 13/506

(57) ABSTRACT

A bus bar screws one ends of first and second fuses. A first terminal-equipped electric wire includes a first main terminal fitting and a first terminal fitting, a second terminal-equipped electric wire includes a second main terminal fitting and a second terminal fitting, a third terminal-equipped electric wire includes a third terminal fitting, a fourth terminal-equipped electric wire includes a fourth terminal fitting, a fifth terminal-equipped electric wire includes a fifth terminal fitting, a sixth terminal-equipped electric wire includes a sixth terminal fitting. A first circuit for connecting another end sides of third and fourth electric wires to a first external electric device, and a second circuit for connecting another end sides of fifth and sixth electric wires to a second external electric device are formed.

### CROSS-REFERENCE TO RELATED APPLICATION(S)

The present application claims priority to and incorporates by reference the entire contents of Japanese Patent Application No. 2023-191621 filed in Japan on Nov. 9, 2023.

### BACKGROUND OF THE INVENTION

### 1. Field of the Invention

The present invention relates to a connector.

### 2. Description of the Related Art

Conventionally, there is a connector in which circuit components such as fuses are prepared for each of a plurality of circuits and aggregated in one housing in order to increase space efficiency of a connector installation location in an installation target or a connection target. For example, Japanese Patent Application Laid-open No. 2019-021639 discloses a connector that includes: a housing in which a plurality of relay terminal fittings are integrally molded; two fuses fitting and connecting male tabs to the relay terminal fittings from a first opening of the housing; and a plurality of bus bars fitting and connecting male tabs to the relay terminal fittings from a second opening located on a back side of the first opening of the housing.

By the way, in this type of connector, versatility can be enhanced if circuit specifications can be changed by changing the connection relationship of the circuit components or stopping change of the circuit components on a small scale without greatly changing the circuit components for each circuit. However, it is difficult for the conventional connector to easily cope with the change in the circuit specifications.

### SUMMARY OF THE INVENTION

Therefore, an object of the present invention is to provide a connector that can easily cope with change in circuit specifications.

In order to achieve the above mentioned object, a connector according to one aspect of the present invention includes a first terminal-equipped electric wire; a second terminal-equipped electric wire; a third terminal-equipped electric wire; a fourth terminal-equipped electric wire; a fifth terminal-equipped electric wire; a sixth terminal-equipped electric wire; a first fuse; a second fuse; a bus bar that is screwed and fixed to one end of the first fuse and one end of the second fuse to electrically connect the one ends to each other; a housing in which the first terminal-equipped electric wire, the second terminal-equipped electric wire, the third terminal-equipped electric wire, the fourth terminal-equipped electric wire, the fifth terminal-equipped electric wire, the sixth terminal-equipped electric wire, the first fuse, the second fuse, and the bus bar are housed in a housing chamber; and a cover that closes an opening of the housing chamber, wherein the first terminal-equipped electric wire includes a first electric wire, a first main terminal fitting provided at one end of the first electric wire and connector-connected to a first mating terminal fitting, and a first terminal fitting provided at the other end of the first electric wire, the second terminal-equipped electric wire includes a second electric wire, a second main terminal fitting provided at one end of the second electric wire and connector-connected to a second mating terminal fitting, and a second terminal fitting provided at the other end of the second electric wire and electrically connected to the one end of the second fuse by screwing and fixing, the third terminal-equipped electric wire includes a third electric wire and a third terminal fitting provided at one end of the third electric wire and electrically connected to the other end of the first fuse by screwing and fixing, the fourth terminal-equipped electric wire includes a fourth electric wire and a fourth terminal fitting provided at one end of the fourth electric wire and electrically connected to the first terminal fitting by screwing and fixing, the fifth terminal-equipped electric wire includes a fifth electric wire and a fifth terminal fitting provided at one end of the fifth electric wire and electrically connected to the other end of the second fuse by screwing and fixing, the sixth terminal-equipped electric wire includes a sixth electric wire and a sixth terminal fitting provided at one end of the sixth electric wire and electrically connected to the first terminal fitting by screwing and fixing, and a first circuit for electrically connecting the other end side of the third electric wire drawn out of the housing and the other end side of the fourth electric wire drawn out of the housing to a first external electric device outside the housing is formed, and a second circuit for electrically connecting the other end side of the fifth electric wire drawn out of the housing and the other end side of the sixth electric wire drawn out of the housing to a second external electric device outside the housing is formed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is a plan view illustrating the connector (excluding a cover) according to the embodiment, which illustrates a first connection mode;

FIG. 3 is an exploded perspective view illustrating the connector (excluding a terminal-equipped electric wire and the cover) of the embodiment;

FIG. 4 is an exploded perspective view illustrating the connector (excluding the cover) according to the embodiment;

FIG. 5 is a plan view illustrating the connector (excluding the cover) according to the embodiment, which illustrates a second connection mode;

FIG. 6 is a plan view illustrating the connector (excluding the cover) according to the embodiment, which illustrates a third connection mode; and

FIG. 7 is a plan view illustrating the connector (excluding the cover) according to the embodiment, which illustrates a fourth connection mode.

### DETAILED DESCRIPTION OF THE PREFERRED EMBODIMENTS

Hereinafter, embodiments of a connector according to the present invention will be described in detail with reference to the drawings. Incidentally, the invention is not limited by the embodiments.

### Embodiment

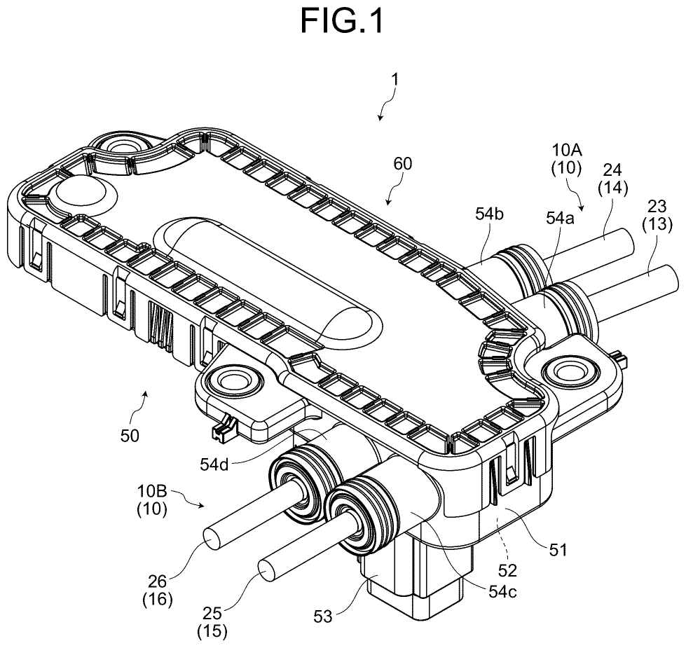

One of the embodiments of the connector according to the present invention will be described with reference to FIGS. 1 to 7.

Reference numeral 1 in FIGS. 1 to 7 represents a connector according to the present embodiment.

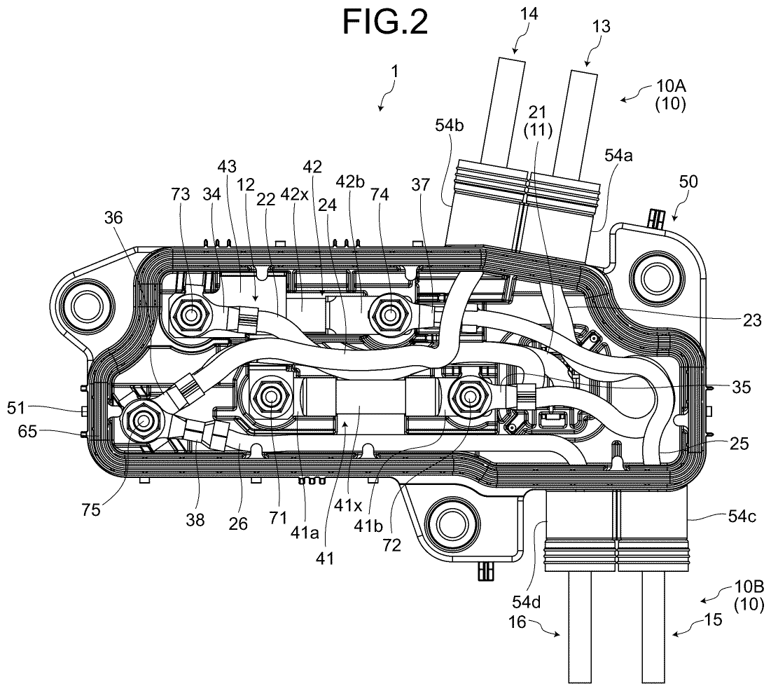

The connector 1 includes a connector circuit 10 (FIGS. 2, 4, and 5). The connector circuit 10 includes a first terminal-equipped electric wire 11, a second terminal-equipped electric wire 12, a third terminal-equipped electric wire 13, a fourth terminal-equipped electric wire 14, a fifth terminal-equipped electric wire 15, and a sixth terminal-equipped electric wire 16 (FIGS. 2, 4, and 5).

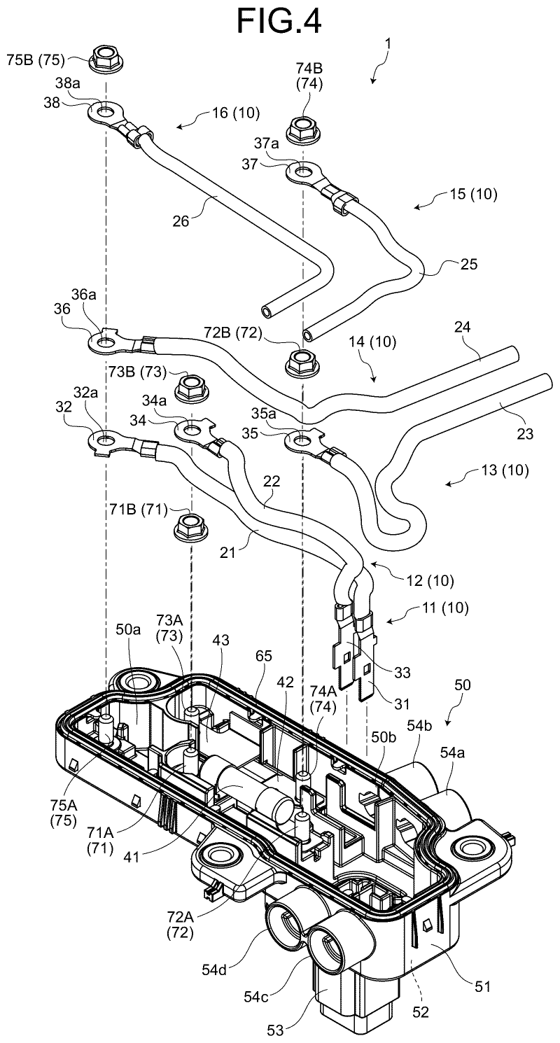

The first terminal-equipped electric wire 11 includes a first electric wire 21, a first main terminal fitting 31 provided at one end of the first electric wire 21 and physically and electrically connected to the one end by crimping or the like, and a first terminal fitting 32 provided at the other end of the first electric wire 21 and physically and electrically connected to the other end by crimping or the like (FIGS. 2 and 4). The second terminal-equipped electric wire 12 includes a second electric wire 22, a second main terminal fitting 33 provided at one end of the second electric wire 22 and physically and electrically connected to the one end by crimping or the like, and a second terminal fitting 34 provided at the other end of the second electric wire 22 and physically and electrically connected to the other end by crimping or the like (FIGS. 2 and 4). The third terminal-equipped electric wire 13 includes a third electric wire 23 and a third terminal fitting 35 provided at one end of the third electric wire 23 and physically and electrically connected to the one end by crimping or the like (FIGS. 2 and 4). The fourth terminal-equipped electric wire 14 includes a fourth electric wire 24 and a fourth terminal fitting 36 provided at one end of the fourth electric wire 24 and physically and electrically connected to the one end by crimping or the like (FIGS. 2 and 4). The fifth terminal-equipped electric wire 15 includes a fifth electric wire 25 and a fifth terminal fitting 37 provided at one end of the fifth electric wire 25 and physically and electrically connected to the one end by crimping or the like (FIGS. 2 and 4). The sixth terminal-equipped electric wire 16 includes a sixth electric wire 26 and a sixth terminal fitting 38 provided at one end of the sixth electric wire 26 and physically and electrically connected to the one end by crimping or the like (FIGS. 2 and 4).

In the connector circuit 10, so-called LA terminals are used for the first terminal fitting 32, the second terminal fitting 34, the third terminal fitting 35, the fourth terminal fitting 36, the fifth terminal fitting 37, and the sixth terminal fitting 38. Therefore, the first terminal fitting 32 has a through-hole 32a through which a male screw member is inserted (FIG. 4). The second terminal fitting 34 has a through-hole 34a through which a male screw member is inserted (FIG. 4). The third terminal fitting 35 has a through-hole 35a through which a male screw member is inserted (FIG. 4). The fourth terminal fitting 36 has a through-hole 36a through which a male screw member is inserted (FIG. 4). The fifth terminal fitting 37 has a through-hole 37a through which a male screw member is inserted (FIG. 4). The sixth terminal fitting 38 has a through-hole 38a through which a male screw member is inserted (FIG. 4).

The connector circuit 10 is electrically connected to a mating connector by connector-connecting the first main terminal fitting 31 to a first mating terminal fitting of the mating connector and connector-connecting the second main terminal fitting 33 to a second mating terminal fitting of the mating connector.

In addition, the connector circuit 10 forms a first circuit 10A that electrically connects the other end side of the third electric wire 23 drawn out of a housing 50, which will be described later, and the other end side of the fourth electric wire 24 drawn out of the housing 50 to a first external electric device outside the housing 50, and forms a second circuit 10B that electrically connects the other end side of the fifth electric wire 25 drawn out of the housing 50 and the other end side of the sixth electric wire 26 drawn out of the housing 50 to a second external electric device outside the housing 50 (FIGS. 1 and 2).

Further, the connector 1 includes a first fuse 41 and a second fuse 42 interposed in the connector circuit 10 (FIGS. 2 to 4). Further, the connector 1 includes a bus bar 43 that is screwed and fixed to one end of each of the first fuse 41 and the second fuse 42 to electrically connect the one ends (FIGS. 2 to 4).

The first fuse 41 and the second fuse 42 are formed in a shaft shape having one end and the other end in the axial direction as electrical connection portions. The first fuse 41 and the second fuse 42 exemplified here are so-called tubular fuses.

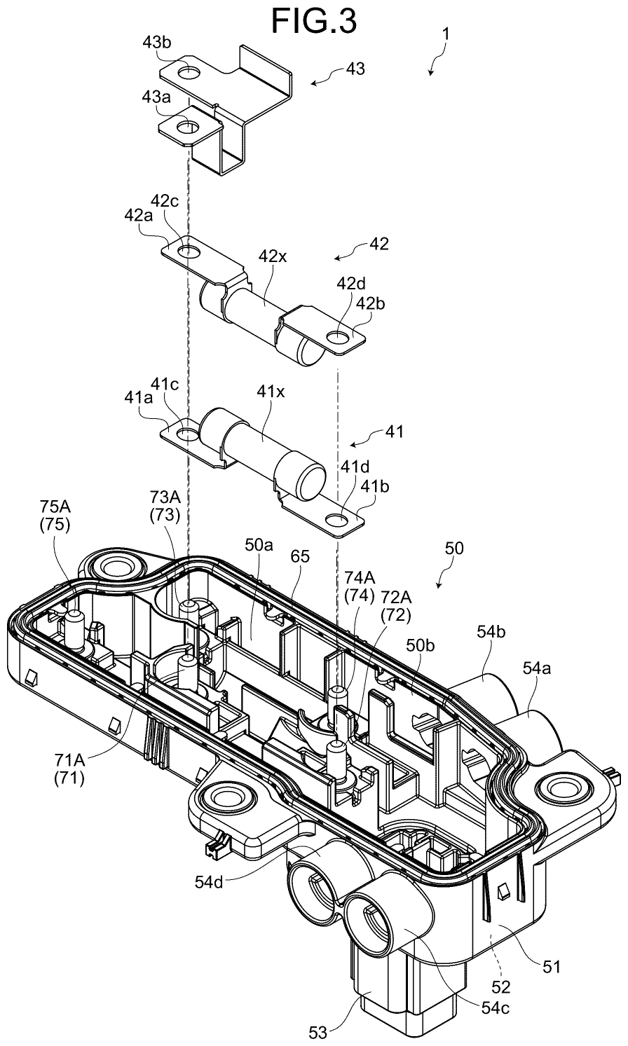

The first fuse 41 is provided with a first terminal portion 41a at one end and a second terminal portion 41b at the other end (FIGS. 2 and 3). The first terminal portion 41a is formed in a flat plate shape and is physically and electrically connected to one end cap of a tubular fuse body 41x. A through-hole 41c having a hole axis orthogonal to the axial direction of the first fuse 41 is formed in the first terminal portion 41a (FIG. 3). In addition, the second terminal portion 41b is formed in a flat plate shape on the same plane as the first terminal portion 41a, and is physically and electrically connected to the other end cap of the fuse body 41x. A through-hole 41d having a hole axis orthogonal to the axial direction of the first fuse 41 is formed in the second terminal portion 41b (FIG. 3). Incidentally, the hole axes of the through-holes 41c and 41d are oriented in the same direction.

The second fuse 42 is provided with a first terminal portion 42a at one end and a second terminal portion 42b at the other end (FIGS. 2 and 3). The first terminal portion 42a is formed in a flat plate shape and is physically and electrically connected to one end cap of a tubular fuse body 42x. A through-hole 42c having a hole axis orthogonal to the axial direction of the second fuse 42 is formed in the first terminal portion 42a (FIG. 3). In addition, the second terminal portion 42b is formed in a flat plate shape on the same plane as the first terminal portion 42a, and is physically and electrically connected to the other end cap of the fuse body 42x. A through-hole 42d having a hole axis orthogonal to the axial direction of the second fuse 42 is formed in the second terminal portion 42b (FIG. 3). Incidentally, the hole axes of the through-holes 42c and 42d are oriented in the same direction.

The first fuse 41 and the second fuse 42 may be the same component having the same shape and the same capacity, or may be different components having the same shape but different capacities.

The bus bar 43 is molded using a conductive material such as metal. In the bus bar 43, a first through-hole 43a disposed coaxially with the through-hole 41c at one end of the first fuse 41 and a second through-hole 43b disposed coaxially with the through-hole 42c at one end of the second fuse 42 are formed (FIG. 3). The bus bar 43 illustrated here is, for example, a plate-shaped press-molded product using a metal plate as a base material.

The connector 1 includes the housing 50 in which the first terminal-equipped electric wire 11, the second terminal-equipped electric wire 12, the third terminal-equipped electric wire 13, the fourth terminal-equipped electric wire 14, the fifth terminal-equipped electric wire 15, the sixth terminal-equipped electric wire 16, the first fuse 41, the second fuse 42, and the bus bar 43 are housed in a housing chamber 50a, and a cover 60 that closes an opening 50b of the housing chamber 50a (FIGS. 1 to 4). In the housing 50, the first fuse 41 and the like are inserted into the housing chamber 50a from the opening 50b. The housing 50 and the cover 60 are molded using an insulating material such as a synthetic resin. Incidentally, an annular packing 65 is provided between the housing 50 and the cover 60 to suppress infiltration of liquid such as water into the housing chamber 50a from therebetween (FIGS. 2 to 4).

The housing 50 includes an annular side wall 51 and a closing portion 52 that closes an opening at one end in the axial direction of the side wall 51 (FIGS. 1 to 4). In the housing 50, a space surrounded by the side wall 51 and the closing portion 52 is used as the housing chamber 50a, and an opening at the other end in the axial direction of the side wall 51 is used as the opening 50b of the housing chamber 50a.

The first fuse 41 illustrated here is housed in the housing chamber 50a with the fuse body 41x thereof facing the opening 50b (FIG. 3). The second fuse 42 illustrated here is housed in the housing chamber 50a with the fuse body 42x thereof facing a bottom wall of the housing chamber 50a (FIG. 3). However, in the housing 50, the first fuse 41 may be housed in the housing chamber 50a with the fuse body 41x facing the bottom wall of the housing chamber 50a, and the second fuse 42 may be housed in the housing chamber 50a with the fuse body 42x facing the opening 50b. In addition, in the housing 50, the first fuse 41 and the second fuse 42 may be housed in the housing chamber 50a with the fuse bodies 41x and 42x facing the opening 50b, or the first fuse 41 and the second fuse 42 may be housed in the housing chamber 50a with the fuse bodies 41x and 42x facing the bottom wall of the housing chamber 50a.

The housing 50 has a tubular connector fitting portion 53 that protrudes from the closing portion 52 to the outside of the housing chamber 50a and has the inner space communicating with the housing chamber 50a (FIGS. 1, 3, and 4). The connector fitting portion 53 is fitted and connected to the mating connector. Therefore, the first main terminal fitting 31 and the second main terminal fitting 33 are inserted into the housing chamber 50a from the opening 50b, and are housed in the inner space the connector fitting portion 53.

In addition, the housing 50 includes a first tubular portion 54a that draws out the third electric wire 23 to the outside of the housing chamber 50a, a second tubular portion 54b that draws out the fourth electric wire 24 to the outside of the housing chamber 50a, a third tubular portion 54c that draws out the fifth electric wire 25 to the outside of the housing chamber 50a, and a fourth tubular portion 54d that draws out the sixth electric wire 26 to the outside of the housing chamber 50a (FIGS. 1 to 4). In the housing 50, the first tubular portion 54a and the second tubular portion 54b aligned side by side with tube axial directions matching each other protrude from the side wall 51 to the outside of the housing chamber 50a, and the third tubular portion 54c and the fourth tubular portion 54d aligned side by side with tube axial directions matching each other protrude from the side wall 51 to the outside of the housing chamber 50a. In the first circuit 10A of the connector 1, the other end side of each of the third electric wire 23 and the fourth electric wire 24 drawn out from the first tubular portion 54a and the second tubular portion 54b to the outside of the housing chamber 50a is electrically connected to the first external electric device. In addition, in the second circuit 10B of the connector 1, the other end side of each of the fifth electric wire 25 and the sixth electric wire 26 drawn out from the third tubular portion 54c and the fourth tubular portion 54d to the outside of the housing chamber 50a is electrically connected to the second external electric device.

In the connector 1, a circuit configuration of the first circuit 10A and the second circuit 10B can be changed by changing connection destination of each of the first terminal fitting 32 of the first terminal-equipped electric wire 11, the second terminal fitting 34 of the second terminal-equipped electric wire 12, the third terminal fitting 35 of the third terminal-equipped electric wire 13, the fourth terminal fitting 36 of the fourth terminal-equipped electric wire 14, the fifth terminal fitting 37 of the fifth terminal-equipped electric wire 15, and the sixth terminal fitting 38 of the sixth terminal-equipped electric wire 16.

For example, in the circuit configuration of the first connection mode illustrated in FIG. 2, the third terminal fitting 35 is electrically connected to the other end (the second terminal portion 41b) of the first fuse 41 by screwing and fixing. In the circuit configuration of the first connection mode, the second terminal fitting 34 is electrically connected to one end (the first terminal portion 42a) of the second fuse 42 by screwing and fixing, and the fifth terminal fitting 37 is electrically connected to the other end (the second terminal portion 42b) of the second fuse 42 by screwing and fixing. In addition, in the circuit configuration of the first connection mode, the fourth terminal fitting 36 and the sixth terminal fitting 38 are electrically connected to the first terminal fitting 32 by screwing and fixing.

Specifically, the housing chamber 50a houses a first screwing structure 71 provided with a first male screw member 71A and a first female screw member 71B that fasten and fix one end (the first terminal portion 41a) of the first fuse 41 and the bus bar 43 together, and a second screwing structure 72 provided with a second male screw member 72A and a second female screw member 72B that fasten and fix the other end (the second terminal portion 41b) of the first fuse 41 and the third terminal fitting 35 together (FIGS. 3 and 4). In addition, the housing chamber 50a houses a third screwing structure 73 provided with a third male screw member 73A and a third female screw member 73B that fasten and fix one end (the first terminal portion 42a) of the second fuse 42, the bus bar 43, and the second terminal fitting 34 together, and a fourth screwing structure 74 provided with a fourth male screw member 74A and a fourth female screw member 74B that fasten and fix the other end (the second terminal portion 42b) of the second fuse 42 and the fifth terminal fitting 37 together (FIGS. 3 and 4). In addition, the housing chamber 50a houses a fifth screwing structure 75 provided with a fifth male screw member 75A and a fifth female screw member 75B that fasten and fix the first terminal fitting 32, the fourth terminal fitting 36, and the sixth terminal fitting 38 together (FIGS. 3 and 4).

In the connector 1 of the first connection mode, the circuit configuration of the first circuit 10A and the second circuit 10B are constructed in which the first terminal-equipped electric wire 11, the fourth terminal-equipped electric wire 14, and the sixth terminal-equipped electric wire 16 form a negative circuit, and the second terminal-equipped electric wire 12, the third terminal-equipped electric wire 13, and the fifth terminal-equipped electric wire 15 form a positive circuit.

Here, for convenience of description, a change from the first connection mode to another connection mode (a second connection mode, a third connection mode, or a fourth connection mode) will be described with reference to the first connection mode.

In the housing chamber 50a, the connection destination of the first terminal fitting 32 of the first terminal-equipped electric wire 11 can be switched from the fifth screwing structure 75 to the third screwing structure 73. In addition, in the housing chamber 50a, the connection destination of the second terminal fitting 34 of the second terminal-equipped electric wire 12 can be switched from the third screwing structure 73 to the fifth screwing structure 75. In addition, in the housing chamber 50a, the connection destination of the third terminal fitting 35 of the third terminal-equipped electric wire 13 can be switched from the second screwing structure 72 to the fifth screwing structure 75. In addition, in the housing chamber 50a, the connection destination of the fourth terminal fitting 36 of the fourth terminal-equipped electric wire 14 can be switched from the fifth screwing structure 75 to the second screwing structure 72. In addition, in the housing chamber 50a, the connection destination of the fifth terminal fitting 37 of the fifth terminal-equipped electric wire 15 can be switched from the fourth screwing structure 74 to the fifth screwing structure 75. In addition, in the housing chamber 50a, the connection destination of the sixth terminal fitting 38 of the sixth terminal-equipped electric wire 16 can be switched from the fifth screwing structure 75 to the fourth screwing structure 74.

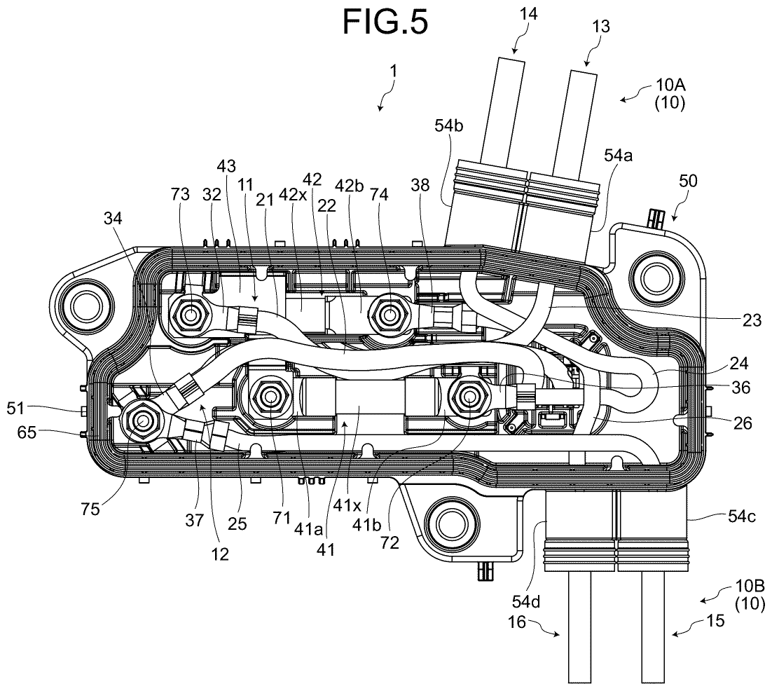

In the connector 1, in the second connection mode illustrated in FIG. 5 in which a connection destination of a target terminal fitting is changed from that in the first connection mode, a circuit configuration of the first circuit 10A and the second circuit 10B are constructed in which the first terminal-equipped electric wire 11, the fourth terminal-equipped electric wire 14, and the sixth terminal-equipped electric wire 16 form a positive circuit, and the second terminal-equipped electric wire 12, the third terminal-equipped electric wire 13, and the fifth terminal-equipped electric wire 15 form a negative circuit. In the circuit configuration of the second connection mode, as compared with the circuit configuration of the first connection mode, polarities of the first main terminal fitting 31 and the second main terminal fitting 33 are switched, polarities of the third electric wire 23 and the fourth electric wire 24 electrically connected to the first external electric device are switched, and polarities of the fifth electric wire 25 and the sixth electric wire 26 electrically connected to the second external electric device are switched.

In addition, in the housing chamber 50a, the connection destination of the first terminal fitting 32 of the first terminal-equipped electric wire 11 can be switched from the fifth screwing structure 75 to the third screwing structure 73, and the connection destination of the second terminal fitting 34 of the second terminal-equipped electric wire 12 can be switched from the third screwing structure 73 to the fifth screwing structure 75.

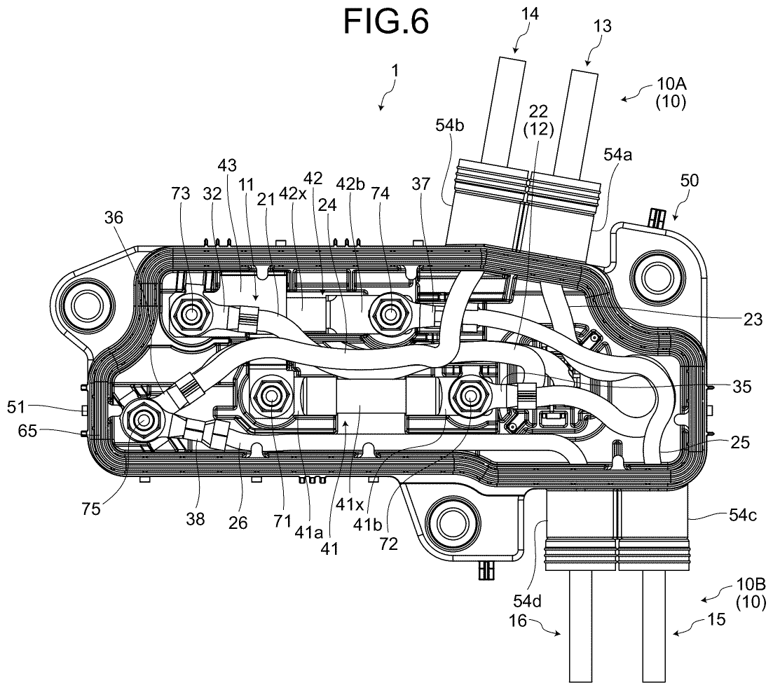

In the connector 1, in the third connection mode illustrated in FIG. 6 in which a connection destination of a target terminal fitting is changed from that in the first connection mode, the circuit configurations of the first circuit 10A and the second circuit 10B are constructed in which the first terminal-equipped electric wire 11, the third terminal-equipped electric wire 13, and the fifth terminal-equipped electric wire 15 form a positive circuit, and the second terminal-equipped electric wire 12, the fourth terminal-equipped electric wire 14, and the sixth terminal-equipped electric wire 16 form a negative circuit. In the circuit configuration of the third connection mode, the polarities of the first main terminal fitting 31 and the second main terminal fitting 33 are switched as compared with the circuit configuration of the first connection mode.

In addition, in the housing chamber 50a, the connection destination of the third terminal fitting 35 of the third terminal-equipped electric wire 13 can be switched from the second screwing structure 72 to the fifth screwing structure 75. In addition, in the housing chamber 50a, the connection destination of the fourth terminal fitting 36 of the fourth terminal-equipped electric wire 14 can be switched from the fifth screwing structure 75 to the second screwing structure 72. In addition, in the housing chamber 50a, the connection destination of the fifth terminal fitting 37 of the fifth terminal-equipped electric wire 15 can be switched from the fourth screwing structure 74 to the fifth screwing structure 75. In addition, in the housing chamber 50a, the connection destination of the sixth terminal fitting 38 of the sixth terminal-equipped electric wire 16 can be switched from the fifth screwing structure 75 to the fourth screwing structure 74.

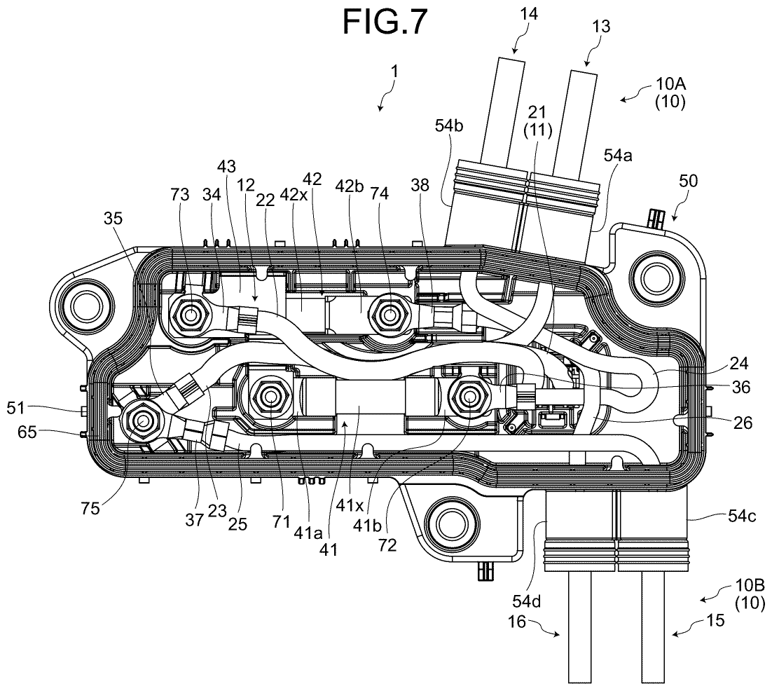

In the connector 1, in the fourth connection mode illustrated in FIG. 7 in which a connection destination of a target terminal fitting is changed from that in the first connection mode, the circuit configurations of the first circuit 10A and the second circuit 10B are constructed in which the first terminal-equipped electric wire 11, the third terminal-equipped electric wire 13, and the fifth terminal-equipped electric wire 15 form a negative circuit, and the second terminal-equipped electric wire 12, the fourth terminal-equipped electric wire 14, and the sixth terminal-equipped electric wire 16 form a positive circuit. In the circuit configuration of the fourth connection mode, as compared with the circuit configuration of the first connection mode, the polarities of the third electric wire 23 and the fourth electric wire 24 electrically connected to the first external electric device are switched, and the polarities of the fifth electric wire 25 and the sixth electric wire 26 electrically connected to the second external electric device are switched.

Since the first fuse 41 and the second fuse 42 are housed in one housing 50 in the connector 1 of the present embodiment as described above, for example, it is possible to reduce cost and enhance space efficiency of a connector installation place in an installation target or a connection target as compared with a case where connectors for a first circuit and a second circuit are provided for each fuse. In addition, in the connector 1 of the present embodiment, the screwing structure is adopted for the connection of the terminal fittings of the respective terminal-equipped electric wires (the first terminal-equipped electric wire 11, the second terminal-equipped electric wire 12, the third terminal-equipped electric wire 13, the fourth terminal-equipped electric wire 14, the fifth terminal-equipped electric wire 15, and the sixth terminal-equipped electric wire 16), and thus the circuit configuration of the first circuit 10A and the second circuit 10B can be easily changed by changing the connection destination of each of the terminal fittings. For example, in the above example, it is possible to interchange the polarities of the first main terminal fitting 31 and the second main terminal fitting 33, the polarities of the third electric wire 23 and the fourth electric wire 24 electrically connected to the first external electric device, and the polarities of the fifth electric wire 25 and the sixth electric wire 26 electrically connected to the second external electric device by changing the connection destination of the terminal fitting.

In addition, in the connector 1, for example, when any one circuit of the first circuit 10A and the second circuit 10B is not necessary, only the other circuit of the first circuit 10A and the second circuit 10B can be formed unless one of the first fuse 41 and the second fuse 42 that is related to the unnecessary circuit is assembled.

In addition, in the connector 1, as described above, it is possible to use the same component having the same shape and the same capacity for the first fuse 41 and the second fuse 42, or to use different components having the same shape but different capacities for the first fuse 41 and the second fuse 42 by limiting shapes (sizes and pitches of the through-holes) of the first fuse 41 and the second fuse 42 to only one specification.

In this manner, the connector 1 of the present embodiment can easily cope with a change in circuit specification.

In a connector according to the present embodiment, a first fuse and a second fuse are housed in one housing, for example, it is possible to reduce cost and enhance space efficiency of a connector installation place in an installation target or a connection target as compared with a case where connectors for a first circuit and a second circuit are provided for each fuse. In addition, the connector according to the present embodiment adopts a screwing structure for connection of terminal fittings of respective terminal-equipped electric wires, and thus a circuit configuration of the first circuit and the second circuit can be easily changed by changing connection destinations of the respective terminal fittings. In addition, in the connector, for example, when any one circuit of the first circuit and the second circuit is not necessary, only the other circuit of the first circuit and the second circuit can be formed unless one of the first fuse and the second fuse that is related to the unnecessary circuit is assembled. As described above, the connector according to the present invention can easily cope with the change in circuit specifications.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a first terminal-equipped electric wire;
a second terminal-equipped electric wire;
a third terminal-equipped electric wire;
a fourth terminal-equipped electric wire;
a fifth terminal-equipped electric wire;
a sixth terminal-equipped electric wire;
a first fuse;
a second fuse;
a bus bar that is screwed and fixed to one end of the first fuse and one end of the second fuse to electrically connect the one ends to each other;
a housing in which the first terminal-equipped electric wire, the second terminal-equipped electric wire, the third terminal-equipped electric wire, the fourth terminal-equipped electric wire, the fifth terminal-equipped electric wire, the sixth terminal-equipped electric wire, the first fuse, the second fuse, and the bus bar are housed in a housing chamber; and
a cover that closes an opening of the housing chamber, wherein
the first terminal-equipped electric wire includes a first electric wire, a first main terminal fitting provided at one end of the first electric wire and connector-connected to a first mating terminal fitting, and a first terminal fitting provided at the other end of the first electric wire,
the second terminal-equipped electric wire includes a second electric wire, a second main terminal fitting provided at one end of the second electric wire and connector-connected to a second mating terminal fitting, and a second terminal fitting provided at the other end of the second electric wire and electrically connected to the one end of the second fuse by screwing and fixing,
the third terminal-equipped electric wire includes a third electric wire and a third terminal fitting provided at one end of the third electric wire and electrically connected to the other end of the first fuse by screwing and fixing,
the fourth terminal-equipped electric wire includes a fourth electric wire and a fourth terminal fitting provided at one end of the fourth electric wire and electrically connected to the first terminal fitting by screwing and fixing,
the fifth terminal-equipped electric wire includes a fifth electric wire and a fifth terminal fitting provided at one end of the fifth electric wire and electrically connected to the other end of the second fuse by screwing and fixing,
the sixth terminal-equipped electric wire includes a sixth electric wire and a sixth terminal fitting provided at one end of the sixth electric wire and electrically connected to the first terminal fitting by screwing and fixing, and
a first circuit for electrically connecting the other end side of the third electric wire drawn out of the housing and the other end side of the fourth electric wire drawn out of the housing to a first external electric device outside the housing is formed, and a second circuit for electrically connecting the other end side of the fifth electric wire drawn out of the housing and the other end side of the sixth electric wire drawn out of the housing to a second external electric device outside the housing is formed.

2. The connector according to claim 1, wherein
each of the first fuse and the second fuse includes a first terminal portion formed in a flat plate shape and physically and electrically connected to one end cap of a fuse body having a tubular shape, and a second terminal portion formed in a flat plate shape on an identical plane with the first terminal portion and physically and electrically connected to the other end cap of the fuse body,
the first fuse is housed in the housing chamber with the fuse body of the first fuse facing the opening, and
the second fuse is housed in the housing chamber with the fuse body of the second fuse facing a bottom wall of the housing chamber.

3. The connector according to claim 2, wherein the housing chamber houses a first screwing structure provided with a first male screw member and a first female screw member that fasten and fix the first terminal portion of the first fuse and the bus bar together, a second screwing structure provided with a second male screw member and a second female screw member that fasten and fix the second terminal portion of the first fuse and the third terminal fitting together, a third screwing structure provided with a third male screw member and a third female screw member that fasten and fix the first terminal portion of the second fuse, the bus bar, and the second terminal fitting together, a fourth screwing structure provided with a fourth male screw member and a fourth female screw member that fasten and fix the second terminal portion of the second fuse and the fifth terminal fitting together, and a fifth screwing structure provided with a fifth male screw member and a fifth female screw member that fasten and fix the first terminal fitting, the fourth terminal fitting, and the sixth terminal fitting together.

4. The connector according to claim 3, wherein a connection destination of the first terminal fitting is switchable from the fifth screwing structure to the third screwing structure, a connection destination of the second terminal fitting is switchable from the third screwing structure to the fifth screwing structure, a connection destination of the third terminal fitting is switchable from the second screwing structure to the fifth screwing structure, a connection destination of the fourth terminal fitting is switchable from the fifth screwing structure to the second screwing structure, a connection destination of the fifth terminal fitting is switchable from the fourth screwing structure to the fifth screwing structure, and a connection destination of the sixth terminal fitting is switchable from the fifth screwing structure to the fourth screwing structure.

5. The connector according to claim 3, wherein a connection destination of the first terminal fitting is switchable from the fifth screwing structure to the third screwing structure, and a connection destination of the second terminal fitting is switchable from the third screwing structure to the fifth screwing structure.

6. The connector according to claim 3, wherein a connection destination of the third terminal fitting is switchable from the second screwing structure to the fifth screwing structure, a connection destination of the fourth terminal fitting is switchable from the fifth screwing structure to the second screwing structure, a connection destination of the fifth terminal fitting is switchable from the fourth screwing structure to the fifth screwing structure, and a connection destination of the sixth terminal fitting is switchable from the fifth screwing structure to the fourth screwing structure.
